(19) United States
(12) Patent Application Publication
(10) Pub. No.: US 2011/0123831 A1
(43) Pub. Date: May 26, 2011

(54) METHOD FOR MANUFACTURING GLASS SUBSTRATE FOR MAGNETIC DISK

(75) Inventors: Tomohiro Sakai, Tokyo (JP); Hiroyuki Tomonaga, Tokyo (JP)

(73) Assignee: Asahi Glass Company, Limited, Chiyoda-ku (JP)

(21) Appl. No.: 12/947,279

(22) Filed: Nov. 16, 2010

(30) Foreign Application Priority Data
Nov. 25, 2009 (JP) 2009-267684

(51) Int. Cl. G11B 5/73; B24B 1/00

(52) U.S. Cl. 428/836; 428/846.9; 451/36; 451/41

(57) ABSTRACT

The present invention relates to a method for manufacturing a glass substrate for a magnetic disk, the method including: a polishing step of supplying a polishing slurry between a polishing cloth and a circular glass plate and polishing a main surface of the circular glass plate by the polishing cloth; and a slurry circulating step of allowing the polishing slurry to contain a polishing slurry used in the polishing step, in which the polishing slurry contains a cerium oxide particle having a median diameter of from 0.3 to 3 μm and an acetylenic surfactant.

### FIELD OF THE INVENTION

The present invention relates to a method for manufacturing a glass substrate for a magnetic disk and relates to a magnetic disk.

### BACKGROUND OF THE INVENTION

In recent years, demands for a high recording density on a magnetic disk to be mounted on information processing devices such as a hard disk drive have been increased. Under such circumstances, a glass substrate has been broadly used in place of the conventional aluminum substrate (see Patent Document 1).

A glass substrate for a magnetic disk is manufactured by, for example, coring a circular hole in the center of a circular glass plate, successively performing chamfering, main surface lapping and edge mirror polishing, performing first-stage polishing with a cerium oxide polishing slurry and then performing second-stage polishing with a colloidal silica polishing slurry to polish the main surface of the circular glass plate.

Patent Document 1: JP-A-2008-105168

### SUMMARY OF THE INVENTION

In the first-stage polishing with a cerium oxide polishing slurry, from the standpoint of necessity for removing a scratch on the main surface of the circular glass plate generated in the lapping step, the polishing with cerium oxide is performed over a long period of time, resulting in causing a lowering of the productivity. However, when a polishing rate is enhanced by using a cerium oxide particle having a large particle size as in the background art, there is a possibility of causing a problem such as generation of a new scratch or deterioration of the shape quality.

Also, in general, the cerium oxide polishing slurry is frequently repeatedly circulated and utilized, and there is a concern that even when a cerium oxide particle having a large particle size is used, the particle is pulverized during the use, so that a desired polishing rate is not obtained.

Then, in view of the foregoing problems, the invention has been made, and an object thereof is to provide a method for manufacturing a glass substrate for a magnetic disk capable of enhancing a polishing rate without increasing a particle size of cerium oxide, and consequently, enhancing the productivity.

In order to solve the foregoing problems, the present inventors made extensive and intensive investigations through addition of various additives to a polishing slurry to seek whether or not the polishing rate can be enhanced. As a result, though they found a perfluoroalkyl carboxylate as an additive capable of enhancing the polishing rate, it has become clear that foaming is caused in the polishing slurry in a slurry circulating step, thereby hindering the polishing step such as a lowering of the polishing rate or leakage of the slurry from a polishing slurry circulating conduit.

The present inventors have found that the problems of the invention including the foregoing issue of foaming can be solved by adopting the following constructions, leading to accomplishment of the invention on the basis of this knowledge. That is, the invention is as follows.

1. A method for manufacturing a glass substrate for a magnetic disk, the method comprising:

a polishing step of supplying a polishing slurry between a polishing cloth and a circular glass plate and polishing a main surface of the circular glass plate by the polishing cloth; and

a slurry circulating step of allowing the polishing slurry to contain a polishing slurry used in the polishing step,

wherein the polishing slurry contains a cerium oxide particle having a median diameter of from 0.3 to 3 μm and an acetylenic surfactant.

2. The method for manufacturing a glass substrate for a magnetic disk according to item 1, wherein the acetylenic surfactant is at least one kind selected from the group consisting of an acetylenic diol surfactant and an acetylenic alcohol surfactant.

3. The method for manufacturing a glass substrate for a magnetic disk according to item 1 or 2, wherein the polishing cloth has a Shore A hardness of 70° or more.

4. A glass substrate for a magnetic disk, which is manufactured by the manufacturing method according to any one of items 1 to 3.

5. A magnetic disk comprising:

a glass substrate for a magnetic disk, which is manufactured by the method for manufacturing a glass substrate for a magnetic disk according to any one of items 1 to 3,

a plurality of layers being laminated on the glass substrate and including a magnetic layer serving as a recording layer.

According to the manufacturing method of the invention, in the case of circulating the polishing slurry and repeatedly using it without using cerium oxide having a large particle size, the polishing rate of glass can be enhanced while suppressing foaming of the polishing slurry.

Also, according to the manufacturing method of the invention, aggregation and sedimentation of a cerium oxide abrasive, which are easily caused when an ionic additive is added to the polishing slurry, can be prevented from occurring.

### DETAILED DESCRIPTION OF THE INVENTION

The invention is hereunder described in detail.

In the manufacturing method of the invention, manufacturing steps other than the polishing step of the main surface of the circular glass plate using the polishing slurry of the invention are not particularly limited but may be adequately chosen, and typically, they are treated according to the conventionally known steps. For example, in general, the glass substrate for a magnetic disk is manufactured through respective steps as listed below. A circular hole is cored in the center of a circular glass plate, followed by successively performing chamfering, main surface lapping and edge mirror polishing. Thereafter, the thus processed circular glass plates are laminated, the inner peripheral edge is etched, and for example, a polysilazane compound-containing liquid is coated on the etched inner peripheral edge by a spraying method or the like and then fired, thereby forming a coating film (protective coating film) on the inner peripheral edge. Subsequently, the main surface of the circular glass plate having a coating film formed on the inner peripheral edge is polished to form a flat and smooth surface, thereby accomplishing a glass substrate for a magnetic disk.

Not only to the foregoing respective steps, for example, brush polishing of the inner peripheral edge may be performed in place of the formation of a protective film on the inner peripheral edge. The main surface lapping step may be divided into a rough lapping step and a precise lapping step, and a shape-processing step (for example, hole-coring in the center of a circular glass plate, chamfering and edge polishing) may be provided between these steps. Also, a chemical reinforcing step may be provided after the main surface polishing step. In the case of manufacturing a glass substrate not having a circular hole in the center thereof, as a matter of course, hole-coring in the center of a circular glass plate is not needed. The main surface lapping is usually performed using an aluminum oxide abrasive or an aluminum oxide-based abrasive, having an average particle size of from 6 to 8 μm.

The manufacturing method of the invention includes a polishing step of polishing the main surface of a circular glass plate using a polishing slurry of the invention (hereinafter sometimes referred to simply as “polishing slurry”) and a slurry circulating step of circulating the polishing slurry used in the polishing step. The respective steps are hereunder described.

### [Polishing Step]

This step is a step of supplying the polishing slurry between a polishing cloth and a circular glass plate and polishing the main surface of the circular glass plate using the polishing cloth. The polishing slurry contains a cerium oxide particle and an acetylenic surfactant.

A median diameter of the cerium oxide particle in the polishing slurry is from 0.3 to 3 μm, preferably from 0.3 to 2.5 μm, and more preferably from 0.5 to 2 μm. When the median diameter is smaller than 0.3 μm, the polishing rate is not sufficient, whereas when it is larger than 3 μm, there is a concern that a scratch is caused.

A concentration of the cerium oxide particle in the polishing slurry is preferably from 1 to 40% by mass, more preferably from 1 to 20% by mass, and especially preferably from 3 to 20% by mass. When the concentration of the cerium oxide particle is less than 1% by mass, polishing does not sufficiently proceed, whereas when it is more than 40% by mass, fluidity is deteriorated.

From the viewpoint of enhancing the polishing rate, TREO (total rare earth oxides) of the cerium oxide particle is preferably 50% or more.

For the purpose of increasing the polishing rate, the polishing slurry contains an acetylenic surfactant. The acetylenic surfactant does not cause foaming of the polishing slurry, or even when it causes foaming, its degree is slight. The acetylenic surfactant is preferably at least one kind selected from the group consisting of an acetylenic diol surfactant and an acetylenic alcohol surfactant.

A concentration of the acetylenic surfactant in the polishing slurry is preferably from 0.01 to 10% by mass, and more preferably from 0.01 to 1% by mass. When the concentration of the acetylenic surfactant is less than 0.01% by mass, the effect for increasing the polishing rate is not obtained, whereas when it is more than 10% by mass, adsorption onto glass occurs, so that there is a concern that the polishing rate is lowered, or organic contamination is generated.

The acetylenic diol surfactant typically has a structure having an alkyl group as a hydrophobic group and having a hydroxyl group as a hydrophilic group, and its affinity with a material to be polished is enhanced by this hydrophilic region, so that a satisfactory polishing rate is obtained.

The acetylenic diol surfactant is preferably a compound represented by the following formula (1). In the formula (1), each of R₁ to R₄ represents a hydrogen atom or a lower alkyl group.

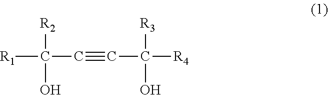

Specific examples of the acetylenic diol surfactant include 2,4,7,9-tetramethyl-5-decyne-4,7-diol and 2,5,8,11-tetramethyl-6-dodecyne-5,8-diol, and polyethoxylates thereof.

Similar to the acetylenic diol surfactant, in the acetylenic alcohol surfactant, a satisfactory polishing rate is obtained in view of the fact that it typically has a structure having an alkyl group as a hydrophobic group and a hydroxyl group as a hydrophilic group.

The acetylenic alcohol surfactant is preferably a compound represented by the following formula (2). In the following formula (2), each of R₁ to R₃ represents a hydrogen atom or a lower alkyl group.

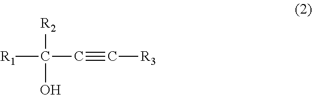

Specific examples of the acetylenic alcohol surfactant include 1-heptyn-3-ol, 1-ethynyl-1-cyclohexanol, 3-butyn-2-ol, 3-butyn-2-ol, 5-hexyn-1-ol, 5-methyl-1-hexyn-3-ol and 5-phenyl-4-pentyn-1-ol.

An HLB (hydrophile-lipophile balance) value of each of the acetylenic diol surfactant and the acetylenic alcohol surfactant is typically 8 or less.

The acetylenic diol surfactant and the acetylenic alcohol surfactant may be mixed and used.

A pH of the polishing slurry is preferably from 7 to 14, more preferably from 7 to 12, and especially preferably from 9 to 12. When the pH is less than 7, there is a concern that the cerium oxide particle is aggregated, whereas when it exceeds 14, there is a concern that a problem is caused in handling.

For the purpose of adjusting the pH, the polishing slurry may contain, for example, at least one pH stabilizer selected from the group consisting of phosphoric acid, acetic acid, propionic acid, malonic acid, succinic acid, glutaric acid, adipic acid, maleic acid, fumaric acid, phthalic acid, citric acid, ethylenediamine, pyridine, 2-aminopyridine, 3-aminopyridine, xanthosine, toluidine, picolinic acid, histidine, piperazine, N-methylpiperazine, 2-bis(2-hydroxyethyl)amino-2-(hydroxymethyl)-1,3-propanediol, uric acid, nitric acid, hydrochloric acid, perchloric acid, oxalic acid and ammonia, and a salt thereof.

For the same purpose, the polishing slurry may contain an alkali metal hydroxide.

Also, the polishing slurry may contain, for example, at least one quaternary ammonium hydroxide selected from the group consisting of tetramethylammonium hydroxide, tetraethylammonium hydroxide and tetrapropylammonium hydroxide as a pH buffer.

Water is used as a solvent of the polishing slurry, and the water is not particularly limited. However, from the viewpoints of influences against other agents, contamination with impurities and influences against the pH and so on, for example, pure water, ultra-pure water and ion exchanged water can be preferably used. Besides, various components may be added to the polishing slurry, if desired.

As the polishing cloth, one having a Shore A hardness of preferably 70° or more, and more preferably 80° or more and typically having closed cells is used. When the Shore A hardness of the polishing cloth is less than 70°, there is a concern that the polishing rate cannot be increased. Also, by using a polishing cloth having closed cells, the polishing slurry is thoroughly held on the polishing cloth, so that an enhancement of the polishing efficiency can be expected. Examples of such a polishing cloth include those made of foamed polyurethane, a porous resin or the like. Also, for the purpose of accelerating the supply of the polishing slurry or allowing a fixed amount of the polishing slurry to stay, the surface of a polishing pad may be subjected to groove processing into a grid-like form, a concentric circular form, a helical form or the like.

A polishing pressure is preferably 4 kPa or more. When the polishing pressure is less than 4 kPa, the stability of the glass substrate is lowered and easily gets in a flap at the time of polishing, and as a result, there is a concern that waviness of the main surface becomes large.

A removal amount of the main surface is suitably from 10 to 40 μm, and the supplied amount and polishing time of the polishing slurry, the concentration of the cerium oxide particle in the polishing slurry, the polishing pressure, the rotation number and the like are adjusted.

After the above polishing of the main surface of the circular glass plate, the glass plate is cleaned and dried to obtain a glass substrate for a magnetic disk. The cleaning and drying are performed by known methods but, for example, immersion into an acidic detergent solution, immersion into an alkaline detergent solution, scrub cleaning with PVA sponge (for example, BELLCLEAN (trade name)) and an alkaline detergent, ultrasonic cleaning in an immersed state in an alkaline detergent solution, and ultrasonic cleaning in an immersed state in pure water are successively performed and then drying is carried out by a method of spin-dry drying, drying with isopropyl alcohol vapor, or the like.

### [Slurry Circulating Step]

This step is a step of circulating the polishing slurry used in the polishing step to provide it for the polishing step. Though the circulation of the polishing slurry is not limited, in general, it can be performed by a conventionally known method, and for example, a method disclosed in JP-A-2001-64039 is exemplified.

### EXAMPLES

The invention is hereunder described by reference to the following Examples, but it should not be construed that the invention is limited thereto. Examples 1 to 5, 10 and 11 are working examples, and others are comparative examples.

### [Fabrication of Specimen]

A silicate glass plate formed through a float process was processed into a doughnut-shaped circular glass plate (circular glass plate having a circular hole in the center thereof) from which a glass substrate having an outer diameter of 65 mm, an inner diameter of 20 mm and a plate thickness of 0.635 mm was obtained. The inner peripheral surface and the outer peripheral surface were subjected to grinding processing with a diamond grindstone; and the top and bottom surfaces of the glass plate were subjected to lapping with an aluminum oxide abrasive.

Subsequently, the inner and outer peripheral edges were subjected to chamfering processing to a chamfering width of 0.15 mm and a chamfering angle of 45°. After chamfering the inner and outer peripheral edges, the edges were subjected to mirror polishing by brush polishing with a cerium oxide slurry as an abrasive and using a brush as a polishing tool. A processing amount was 30 μm in terms of a removal amount in the radiation direction.

### Preparation of Polishing Slurry

### Example 1

20 g of cerium oxide (E30, manufactured by Mitsui Mining & Smelting Co., Ltd., average particle size: 1.2 to 1.6 μm), 0.2 g of an acetylenic diol surfactant (SURFYNOL 104PA, manufactured by Air Products Japan, Inc., active ingredient: 50% by mass, HLB: 4) and 179.8 g of pure water were mixed to obtain a polishing slurry A1 having an abrasive concentration of 10% by mass and a surfactant concentration of 0.05% by mass.

Also, in order to evaluate an enhancement of the polishing rate of Example 1 in terms of a ratio to a surfactant-free polishing slurry, a polishing slurry A1′ for comparison was prepared. That is, 20 g of cerium oxide (E30, manufactured by Mitsui Mining & Smelting Co., Ltd., average particle size: 1.2 to 1.6 μm) and 180 g of pure water were mixed to obtain a surfactant-free polishing slurry A1′ having an abrasive concentration of 10% by mass.

### Examples 2 and 3

Polishing slurries A2 (Example 2) and A3 (Example 3) were prepared in the same manner as in Example 1, except for changing the surfactant concentration as shown in Table 1. Also, for comparison, surfactant-free polishing slurries A2′ and A3′ corresponding to the polishing slurries A2 and A3 were prepared in the same manner as in Example 1.

### Examples 4 and 5

2.5 kg of cerium oxide (E30, manufactured by Mitsui Mining & Smelting Co., Ltd., average particle size: 1.2 to 1.6 μm), 0.25 kg of an acetylenic diol surfactant (SURFYNOL 104PA, manufactured by Air Products Japan, Inc., active ingredient: 50% by mass, HLB: 4) and 22.475 kg of pure water were mixed to obtain polishing slurries A4 (Example 4) and A5 (Example 5) each having an abrasive concentration of 10% by mass and a surfactant concentration of 0.05% by mass.

Also, polishing slurries A4′ and A5′ for comparison, in which the surfactant concentration in each of the polishing slurries A4 and A5 was 0, were prepared.

### Example 6

20 g of cerium oxide (E30, manufactured by Mitsui Mining & Smelting Co., Ltd., average particle size: 1.2 to 1.6 μm), 0.1 g of a perfluoroalkyl carboxylate surfactant (SURFLON (model number: S-111n), manufactured by AGC Seimi Chemical Co., Ltd., active ingredient: 100% by mass) and 179.9 g of pure water were mixed to obtain a polishing slurry B1 having an abrasive concentration of 10% by mass and a surfactant concentration of 0.05% by mass.

Also, a polishing slurry B1′ for comparison, in which the surfactant concentration in the polishing slurry B1 was 0, was prepared.

### Example 7

A polishing slurry B2 was prepared in the same manner as in Example 6, except for changing the surfactant concentration to 0.5% by mass.

Also, a polishing slurry B2′ for comparison, in which the surfactant concentration in the polishing slurry B2 was 0, was prepared.

### Example 8

20 g of cerium oxide (E30, manufactured by Mitsui Mining & Smelting Co., Ltd., average particle size: 1.2 to 1.6 μm), 2 g of a polyether amine surfactant (ED600, manufactured by Huntsman, active ingredient: 100% by mass) and 178 g of pure water were mixed to obtain a polishing slurry C1 having an abrasive concentration of 10% by mass and a surfactant concentration of 1% by mass.

Also, a polishing slurry C1′ for comparison, in which the surfactant concentration in the polishing slurry C1 was 0, was prepared.

### Example 9

2.5 kg of cerium oxide (E30, manufactured by Mitsui Mining & Smelting Co., Ltd., average particle size: 1.2 to 1.6 μm), 0.25 kg of a polyether amine surfactant (ED600, manufactured by Huntsman, active ingredient: 100% by mass) and 22.5 kg of pure water were mixed to obtain a polishing slurry C2 having an abrasive concentration of 10% by mass and a surfactant concentration of 1% by mass.

Also, a polishing slurry C2′ for comparison, in which the surfactant concentration in the polishing slurry C2 was 0, was prepared.

### Example 10

20 g of cerium oxide (E30, manufactured by Mitsui Mining & Smelting Co., Ltd., average particle size: 1.2 to 1.6 μm), 1 g of an acetylenic alcohol surfactant (manufactured by KANTO CHEMICAL CO., INC.; a reagent: 1-octyn-3-ol, active ingredient: 100% by mass) and 179 g of pure water were mixed to obtain a polishing slurry D1 having an abrasive concentration of 10% by mass and a surfactant concentration of 0.5% by mass.

Also, a polishing slurry D1′ for comparison, in which the surfactant concentration in the polishing slurry D1 was 0, was prepared.

### Example 11

20 g of cerium oxide (E30, manufactured by Mitsui Mining & Smelting Co., Ltd., average particle size: 1.2 to 1.6 μm), 1 g of an acetylenic alcohol surfactant (manufactured by KANTO CHEMICAL CO., INC.; a reagent: 3,5-dimethyl-1-hexyn-3-ol, active ingredient: 100% by mass) and 179 g of pure water were mixed to obtain a polishing slurry D2 having an abrasive concentration of 10% by mass and a surfactant concentration of 0.5% by mass.

Also, a polishing slurry D2′ for comparison, in which the surfactant concentration in the polishing slurry D2 was 0, was prepared.

Characteristics of each of the polishing slurries of Examples 1 to 11 obtained by the foregoing methods were evaluated in the following methods. The obtained results are shown in Table 1. Examples 1 to 5, 10 and 11 are working examples, and others are comparative examples.

(1) pH:

A pH of the polishing slurry was measured by D-54 (manufactured by Horiba, Ltd.).

### (2) Foaming Evaluation:

As to foaming of the polishing slurry, after charging 100 g of the polishing slurry into a 250-mL lidded container and shaking the container for 30 seconds, a time until generated foams disappeared was measured. The shorter the time until the generated foams disappear, the more suppressed the foaming of the polishing slurry is. In the table, the terms “just after” mean that the foams disappeared just after shaking.

### (3) Evaluation of Dispersibility:

In order to evaluate dispersibility of the cerium oxide particle in the polishing slurry, particle size distribution of the polishing slurry was measured using LA-950V2, manufactured by Horiba, Ltd., and a median diameter was calculated. The smaller the median diameter, the more suppressed the aggregation of the cerium oxide particle is. The median diameter is preferably 2 μm or less.

### [Polishing of Main Surface]

The main surface of the foregoing specimen was polished for 50 minutes under the following condition while circulating the polishing slurry. Subsequently, the polished specimen was successively subjected to immersion into an acidic detergent solution, immersion into an alkaline detergent solution, scrub cleaning with a PVA sponge and an alkaline detergent, immersion into an alkaline detergent solution and ultrasonic cleaning in an immersed state in pure water, followed by performing spin drying. At every time when the polishing slurry was exchanged, a polishing pad was subjected to brush cleaning for 3 minutes while supplying pure water. Thereafter, a polishing rate was measured. Also, in order to compare and evaluate the polishing rate of each of the Examples, a polishing rate was measured in the same manner by using a surfactant-free polishing slurry in each of the Examples.

### Polishing Machine:

Single side polishing machine (FAM12B, manufactured by Speedfam Co., Ltd.) (Examples 1 to 3, 6 to 8, 10 and 11)

Polishing slurry supplying rate: 100 mL/min

Platen circumferential speed: 40 rpm

Polishing pad: FX8H (Shore A hardness: 93, manufactured by Fujibo Holdings, Inc.) (closed cell type)

Polishing pressure: 12 kPa (Examples 1 to 3, 6 to 8, 10 and 11)

Double side polishing machine (DSM9B, manufactured by Speedfam Co., Ltd.) (Examples 4, 5 and 9)

Polishing slurry supplying rate: 3 L/min

Lower platen circumferential speed: 35 rpm

Polishing pad: FX8H (Shore A hardness: 93, manufactured by Fujibo Holdings, Inc.) (closed cell type)

Polishing pressure: 6 kPa (Example 4), 8.5 kPa (Examples 5 and 9)

### [Polishing Rate]

A polishing rate was determined from a change in weight before and after polishing, a polishing and a density of the specimen. In Table 1, the polishing rate is shown in terms of a relative value (polishing rate ratio) while defining a polishing rate in the case of using a surfactant-free polishing slurry as 1. For example, as to the polishing rate of Example 1, a value obtained by diving the polishing rate in the polishing slurry A1 by the polishing rate in the polishing slurry A1′ for comparison is defined as a polishing rate ratio of Example 1. The polishing rate is preferably 1.03 or more. When the polishing rate is less than 1.03, it is hard to say that the polishing rate was substantially enhanced.

TABLE 1

| | | | Characteristics of | | | | | |
|---|---|---|---|---|---|---|---|---|
| | | | polishing slurry | | | Polishing condition | | |
| | Surfactant | | | | Median | | Processing | |
| | Chemical | Concentration | | | diameter | | pressure | Polishing |
| Example | species | (% by mass) | pH | Antifoaming | (μm) | Polisher | (kPa) | rate ratio |
| 1 | Acetylene diol | 0.05 | 9.6 | Just after | 1.72 | FAM12B | 12 | 1.13 |
| 2 | Acetylene diol | 0.3 | 9.8 | Just after | 1.9 | FAM12B | 12 | 1.07 |
| 3 | Acetylene diol | 0.5 | 9.8 | Just after | 1.87 | FAM12B | 12 | 1.1 |
| 4 | Acetylene diol | 0.05 | 9.6 | Just after | 1.72 | DSM9B | 6 | 1.49 |
| 5 | Acetylene diol | 0.05 | 9.6 | Just after | 1.72 | DSM9B | 8.5 | 1.35 |
| 6 | Perfluoroalkyl | 0.05 | 9.5 | 12 hours or | 2.28 | FAM12B | 12 | 0.98 |
| | carboxylate | | | more | | | | |
| 7 | Perfluoroalkyl | 0.5 | 8.7 | 12 hours or | 2.26 | FAM12B | 12 | 1.12 |
| | carboxylate | | | more | | | | |
| 8 | Polyether amine | 1 | 9.8 | 10 seconds | 1.98 | FAM12B | 12 | 0.91 |
| 9 | Polyether amine | 1 | 9.8 | 10 seconds | 1.98 | DSM9B | 8.5 | 0.96 |
| 10 | Acetylene | 0.5 | 9.6 | Just after | 1.4 | FAM12B | 12 | 1.08 |
| | alcohol | | | | | | | |
| 11 | Acetylene | 0.5 | 9.6 | 15 seconds | 1.65 | FAM12B | 12 | 1.11 |
| | alcohol | | | | | | | |

As shown in Table 1, in Examples 1 to 5, 10 and 11 in which the acetylenic diol surfactant or acetylenic alcohol surfactant is added to the polishing slurry according to the invention, the polishing rate was enhanced. Also, the polishing slurries of Examples 1 to 5, 10 and 11, in which the acetylenic diol surfactant or acetylenic alcohol surfactant is added, were favorable in antifoaming and excellent in dispersibility of the cerium oxide abrasive.

While the invention has been described in detail with reference to specific embodiments thereof, it will be apparent to one skilled in the art that various changes and modifications can be made therein without departing from the spirit and scope thereof.

Incidentally, the present application is based on Japanese Patent Application No. 2009-267684 filed on Nov. 25, 2009, and the contents are incorporated herein by reference.

All references cited herein are incorporated by reference herein in their entirety.

Also, all the references cited herein are incorporated as a whole.

The method of the invention can be utilized for manufacture of a glass substrate for a magnetic disk.

What is claimed is:

1. A method for manufacturing a glass substrate for a magnetic disk, said method comprising:
a polishing step of supplying a polishing slurry between a polishing cloth and a circular glass plate and polishing a main surface of the circular glass plate by the polishing cloth; and
a slurry circulating step of allowing the polishing slurry to contain a polishing slurry used in the polishing step,
wherein the polishing slurry contains a cerium oxide particle having a median diameter of from 0.3 to 3 μm and an acetylenic surfactant.

2. The method for manufacturing a glass substrate for a magnetic disk according to claim 1, wherein the acetylenic surfactant is at least one kind selected from the group consisting of an acetylenic diol surfactant and an acetylenic alcohol surfactant.

3. The method for manufacturing a glass substrate for a magnetic disk according to claim 1, wherein the polishing cloth has a Shore A hardness of 70° or more.

4. A glass substrate for a magnetic disk, which is manufactured by the manufacturing method according to claim 1.

5. A magnetic disk comprising:
a glass substrate for a magnetic disk, which is manufactured by the method for manufacturing a glass substrate for a magnetic disk according to claim 1,
a plurality of layers being laminated on the glass substrate and including a magnetic layer serving as a recording layer.
